(19) United States
(12) Patent Application Publication
(10) Pub. No.: US 2026/0051670 A1
(43) Pub. Date: Feb. 19, 2026

(54) EXHAUST AFTER-TREATMENT SYSTEM AND LUG CONNECTOR

(71) Applicant: PACCAR Inc, Bellevue, WA (US)

(72) Inventors: Jacob Strain, Bellevue, WA (US); Scott Bailey, Bellevue, WA (US); Brannon Hudson, Bellevue, WA (US); Stephen Phillips, Bellevue, WA (US)

(21) Appl. No.: 19/080,303

(22) Filed: Mar. 14, 2025

Related U.S. Application Data
(60) Provisional application No. 63/683,012, filed on Aug. 14, 2024.

(51) Int. Cl. H01R 4/02; F01N 3/20

(52) U.S. Cl. CPC H01R 4/029; F01N 3/2013; F01N 3/2066; F01N 2240/16

(57) ABSTRACT

An exhaust after-treatment system configured to reduce emissions present in exhaust received from an engine is provided and may include an electrically powered heater and an electrically conductive cable. The electrically powered heater may be configured to selectively heat a component of the exhaust after-treatment system and/or exhaust moving through the exhaust after-treatment system during operation. The electrically powered heater may include a heating element and an electrical terminal. The electrically conductive cable may be configured to supply electrical power to the electrically powered heater. The electrically conductive cable may include a lug connector. The electrically conductive cable may be coupled to the electrical terminal of the electrically powered heater by a welded connection directly between the lug connector of the electrically conductive cable and the electrical terminal. A connector lug is also disclosed herein.

### CROSS REFERENCE TO RELATED APPLICATIONS

This application claims priority to U.S. Provisional Patent Application No. 63/683,012, filed on Aug. 14, 2024, the entire contents of which are incorporated herein by reference.

### BACKGROUND

### Technical Field

The present disclosure relates generally to an exhaust after-treatment system, and an electrical connection which may be used therein.

### Description of the Related Art

Exhaust after-treatment systems, including catalytic converter systems, may be used as part of exhaust systems to convert exhaust gases resulting from a combustion process of an engine into less toxic gases, by way of a conversion process. Such exhaust after-treatment systems may be present in vehicles, such as cars, light-duty trucks, and heavy-duty trucks. Exhaust after-treatment systems operate most efficiently when a temperature of the gases being converted are above a minimum temperature. However, gases may not reach such temperatures when being emitted from an engine when the engine has not reached such temperatures, such as in cold start and light load situations.

In order to ensure the gases reach the minimum temperature, one or more heaters may be coupled to the exhaust after-treatment system to heat the gases passing therethrough. Such heaters may be positioned at an inlet of the exhaust after-treatment system to heat the gases, at a Selective Catalytic Reduction module (“SCR module”) to heat the chemicals involved in the conversion process, or in other positions. Such heaters may be necessary to make the exhaust after-treatment system efficient such that governmental emission regulations are satisfied.

The heaters are commonly electrically powered and include electrical terminals extending away from the heater, to reduce heat subjected to the electrical terminals. The electrical terminals are coupled to connectors stemming from electrically conductive cables which lead to a power source. The power source may selectively provide power to the heater. Commonly, these connectors are coupled to the electrical terminals by way of mechanical fasteners, such as nuts and bolts. However, these connections may be subjected to high heat due in part to the close proximity of the connection to the heater. Because of the high heat and other factors, such connections may be prone to failure.

Additionally, high temperatures may cause increased electrical resistance, due to space between wires of an electrically conductive cable. Such resistance may compound the risk of failure described above.

### BRIEF SUMMARY

Embodiments described herein include exhaust after-treatment systems that are configured to improve reliability of connections associated with heaters of the exhaust after-treatment systems. Embodiments also describe a lug connector which may be used in such an exhaust after-treatment system.

The exhaust after-treatment system includes an electronically powered heater and at least one electrically conductive cable. The electrically powered heater is configured to selectively heat one or more components of the exhaust after-treatment system and/or exhaust moving through the exhaust after-treatment system during operation. The electrically powered heater includes a heating element and at least one electrical terminal operatively coupled to the heating element for selectively supplying electrical power thereto. The at least one electrically conductive cable is configured to supply electrical power to the electrically powered heater. The at least one electrically conductive cable including a lug connector on a terminal end thereof. The at least one electrically conductive cable is coupled to the at least one electrical terminal of the electrically powered heater by a welded connection directly between the lug connector of the at least one electrically conductive cable and the at least one electrical terminal.

In some embodiments, a heat sink may be coupled to the cold pin during welding. In further embodiments, prior to welding of the lug connector to the electrical terminal, a pair of heat shields may be positioned on opposing sides of the welding location. A first heat shield of the pair of heat shields may be positioned on the electrically conductive cable and a second heat shield of the pair of heat shields may be positioned on the electrical terminal. The pair of heat shields are configured to reduce heat transfer from a welding connection on a first side of each respective heat shield to a second side of each respective heat shield. The pair of heat shields may be cooled prior to positioning the heat shield on the opposing sides of the welding location. The pair of heat shields may be cooled, for example, in a cooling fluid comprising liquid nitrogen.

The lug connector includes a cable connection portion and a terminal portion. The cable connection portion is configured to insertably receive an electrically conductive cable therein. The terminal portion is configured to be welded to an electrical terminal of an electric heater. The lug connector is configured to conduct electricity from the electrically conductive cable to the electrical terminal of the electric heater.

In some embodiments, the lug connector may be crimped to the electrically conductive wires therein. The lug connector may be crimped such that wires of a portion of the electrically conductive cable are compacted within the lug connector. The cable connection portion of the lug connector may be crimped from an initial circular cross-sectional shape into a hexagonal cross-sectional shape. The lug connector may be plastically deformed by a die. Following crimping, wires of the electrically conductive cable may be compacted such that a resistance across the crimped portion of the compacted wires of the electrically conductive cable is less than 15 microohms, less than 10 microohms, less than 5 microohms, less than 2 microohms, or less than 1.5 microohms. A cross-section of the crimped portion of the compacted wires of the electrically conductive cable consists of an area of solid metal that is entirely devoid or essentially entirely devoid of any interstitial voids among the compacted wires of the cable.

Among other benefits, aspects of the embodiments disclosed herein may provide a more reliable connection of cables to an electrical terminal of a heater, such as those used in exhaust after-treatment systems.

### BRIEF DESCRIPTION OF THE SEVERAL VIEWS OF THE DRAWINGS

FIG. 1 shows a perspective view of an exemplary exhaust after-treatment system.

FIG. 2A shows a side view of an electrical terminal of an electrically powered heater of an exhaust after-treatment system.

FIG. 2B shows a side view of another electrical terminal of an electrically powered heater of an exhaust after-treatment system.

FIG. 3 shows a perspective view of a lug connector welded to an electrical terminal of an electrically powered heater of the exhaust after-treatment system of FIG. 1.

FIG. 4 shows a perspective view of heat shrink wrap covering the welded connection of FIG. 2.

FIG. 5 shows a perspective view of an exemplary lug connector in an initial state.

FIG. 6 shows a rear plan view of the lug connector of FIG. 5.

FIG. 7 shows a cross-section side view of the lug connector of FIG. 5.

FIG. 8 shows a top plan view of an electrically conductive cable received in the lug connector of FIG. 5.

FIG. 9 shows a perspective view of the lug connector of FIG. 5 in a crimped state.

FIG. 10 shows a rear plan view of the lug connector of FIG. 9.

FIG. 11A shows a cross-section view of a cable connection portion of the lug connector of FIG. 9.

FIG. 11B shows an image of a cross-section view of a cable connection portion of a lug connector embodying the embodiment shown in FIG. 9.

FIG. 12A shows a front view of the lug connector of FIG. 5 in an initial crimp state.

FIG. 12B shows a cross-section side view of the lug connector of FIG. 12A in the initial crimp state.

FIG. 13 shows a perspective view of the lug connector of FIG. 5 in a crimped state according to a second embodiment.

FIG. 14 shows a rear plan view of the lug connector of FIG. 13.

FIG. 15A shows a cross-section view of a cable connection portion of the lug connector of FIG. 13.

FIG. 15B shows an image of a cross-section view of a cable connection portion of a lug connector embodying the embodiment shown in FIG. 9.

FIG. 16 shows a perspective view of an exemplary die for crimping a cable connection portion of a lug connector.

FIG. 17 shows a perspective view of a lug connector positioned on an electrical terminal of an electrically powered heater of an exhaust after-treatment system prior to welding.

FIG. 18 shows a side view of a heat shield coupled to a lug connector positioned on an electrical terminal prior to welding.

FIG. 19 shows a side view of a heat shield coupled to an electrical terminal of an electrically powered heater of an exhaust after-treatment system.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known structures and techniques associated with exhaust after-treatment system may not be shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

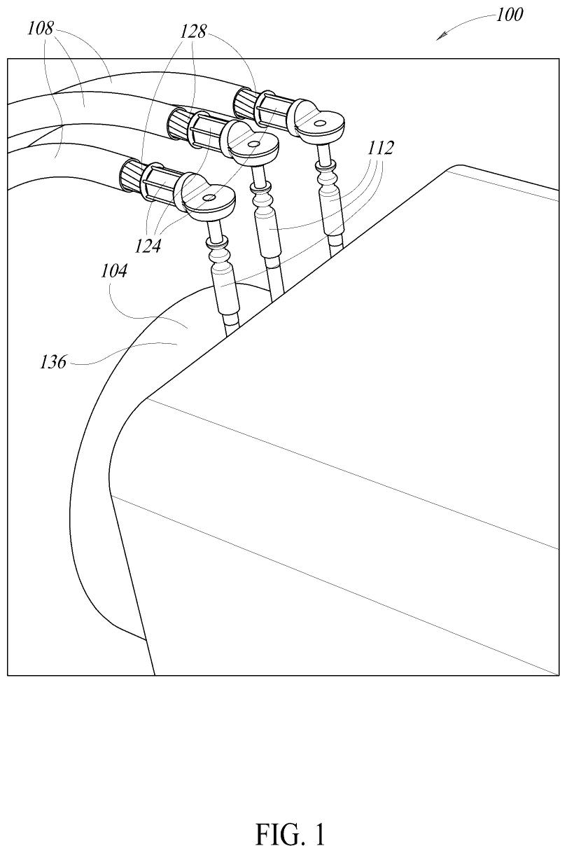

FIG. 1 shows an exhaust after-treatment system 100 configured to reduce emissions present in exhaust received from an engine. The exhaust after-treatment system 100 may include an electrically powered heater 104 and at least one electrically conductive cable 108.

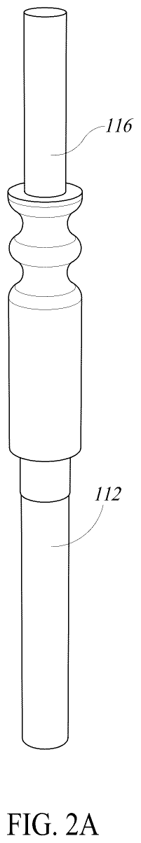

The electrically powered heater 104 may be configured to selectively heat one or more components of the exhaust after-treatment system 100 and/or exhaust moving through the exhaust after-treatment system 100 during operation. The electrically powered heater 104 may include a heating element and at least one electrical terminal 112 operatively coupled to the heating element for selectively supplying electrical power thereto. Each electrical terminal 112 may be a cold pin, such as the cold pin shown in FIG. 2A. Each cold pin may include a core 116. In some embodiments, each cold pin may include a taper cover 120 over the core 116, as shown in FIG. 2B. The taper cover 120 may be electrically conductive such that the taper cover 120 may be used to establish electrical connections to the cold pin, and ultimately, the electrically powered heater 104.

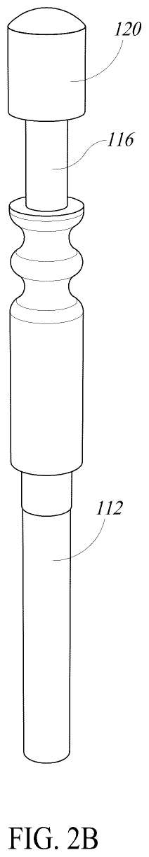

The at least one electrically conductive cable 108 may be configured to supply electrical power to the electrically powered heater 104 from a power source. The at least one electrically conductive cable 108 may be configured to withstand high temperatures, such as those which may be present in a vicinity of a heater. The at least one electrically conductive cable 108 may include a lug connector 124 on a terminal end 128 thereof. The at least one electrically conductive cable 108 may be coupled to the at least one electrical terminal 112 of the electrically powered heater 104 by a welded connection 132 directly between the lug connector 124 of the at least one electrically conductive cable 108 and the at least one electrical terminal 112. An example of such a welded connection 132 between the at least one electrically conductive cable 108 and the at least one electrical terminal 112 is shown in FIG. 3.

In some embodiments, the at least one electrically conductive cable 108 may be welded to the at least one electrical terminal 112 at an inlet 136 of the exhaust after-treatment system 100. In such embodiments, the electrically powered heater 104 may be configured to heat the inlet 136 of the exhaust after-treatment system 100.

Alternatively or additionally, the at least one electrically conductive cable 108 may be welded to the at least one electrical terminal 112 at or proximate an SCR module of the exhaust after-treatment system 100. In such embodiments, the electrically powered heater 104 may be configured to heat the SCR module of the exhaust after-treatment system 100 and/or a region of the exhaust after-treatment system 100 proximate the SCR module.

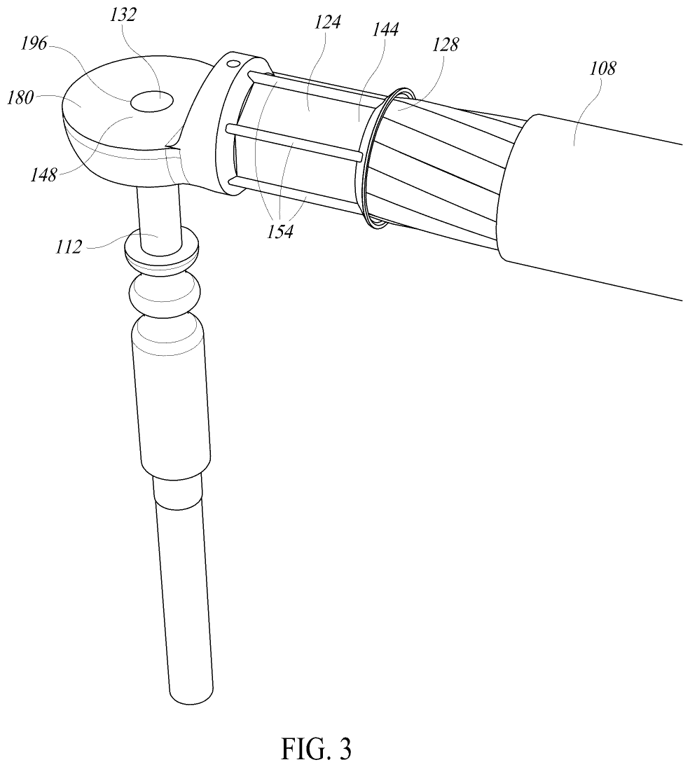

The welded connection 132 of the at least one electrically conductive cable 108 and the at least one electrical terminal 112 may be encased in a heat shrink wrap 140, as shown in FIG. 4. The heat shrink wrap 140 may protect the welded connection 132 from debris, such as dirt and water. In some embodiments, an adhesive may be applied to the heat shrink wrap 140 to further couple the heat shrink wrap 140 to at least one of the at least one electrically conductive cable 108 and the at least one electrical terminal 112. In this manner, the heat shrink wrap 140 may provide a seal around the welded connection and help protect it from fouling or deterioration.

The exhaust after-treatment system 100 may include a plurality of electrically conductive cables 108 and the electrically powered heater 104 may comprise a plurality of electrical terminals 112. Each of the plurality of electrically conductive cables 108 may be welded to a respective one of the plurality of electrical terminals 112.

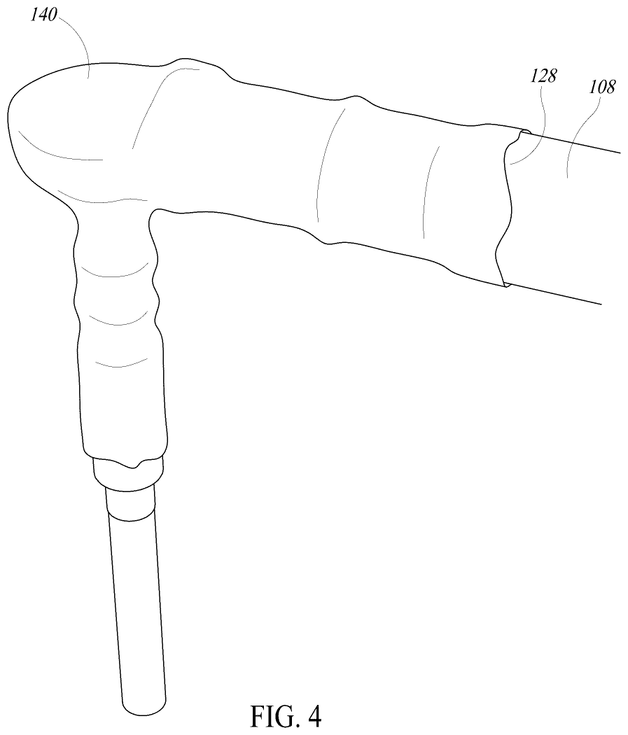

FIGS. 5-11 show an exemplary lug connector 124, which may be utilized as the lug connector 124 described above. The lug connector 124 of FIGS. 5-8 is shown in an initial state I. The lug connector 124 may include a cable connection portion (i.e., a crimp cylinder) 144 and a terminal portion 148 in the form of a ring, for example. The lug connector 124 may be configured to conduct electricity from the electrically conductive cable 108 to an electrical connection, such as the electrical connection with the electrical terminal 112 of the electrically powered heater 104.

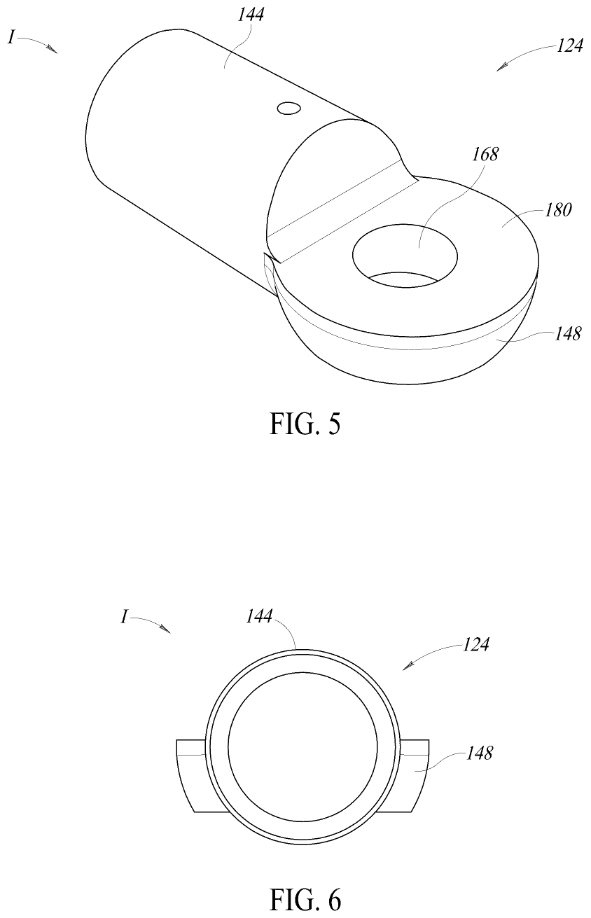

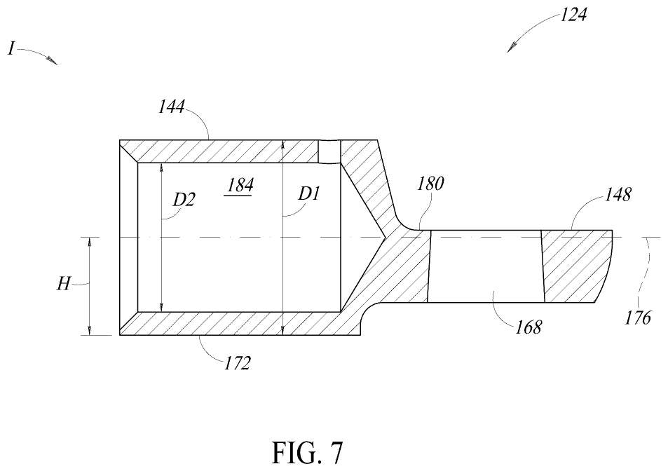

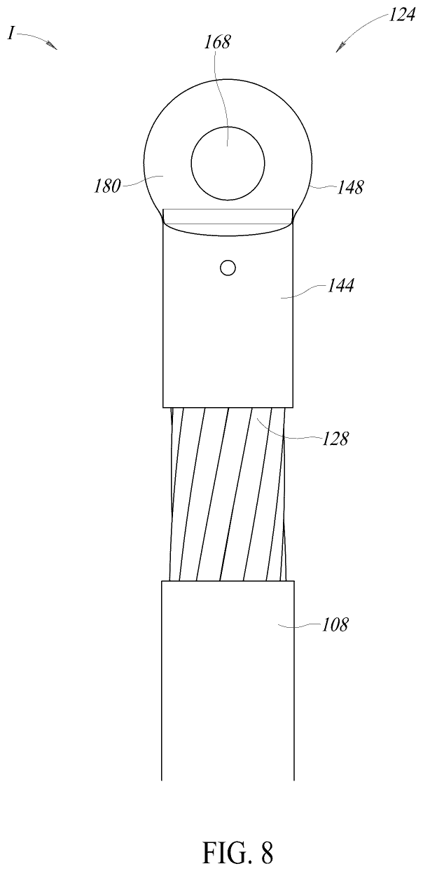

The cable connection portion 144 may include a circular cross-sectional shape in the initial state I. The cable connection portion 144 may be configured to insertably receive an electrically conductive cable 108 therein, as shown in FIG. 8. With reference to FIGS. 6 and 7, a ratio of an outer diameter D1 of the cable connection portion 144 to an inner diameter D2 of the cable connection portion 144 in the initial state I may be between about 1.3 and about 1.4. In some embodiments, the ratio of the outer diameter D1 of the cable connection portion 144 to the inner diameter D2 of the cable connection portion 144 in the initial state I may be between about 1.2 and about 1.5. In some embodiments, the ratio of the outer diameter D1 of the cable connection portion 144 to the inner diameter D2 of the cable connection portion 144 in the initial state I may be between about 1.1 and about 1.6.

In some embodiments, the lug connector 124 may comprise copper. Specifically, the lug connector 124 may comprise copper C110. In some embodiments, the lug connector 124 may comprise nickel. Specifically, the lug connector 124 may comprise nickel 200. In some embodiments, the lug connector 124 may include copper plated with nickel. In additional embodiments, the lug connector 124 may comprise copper C110 plated with nickel 200.

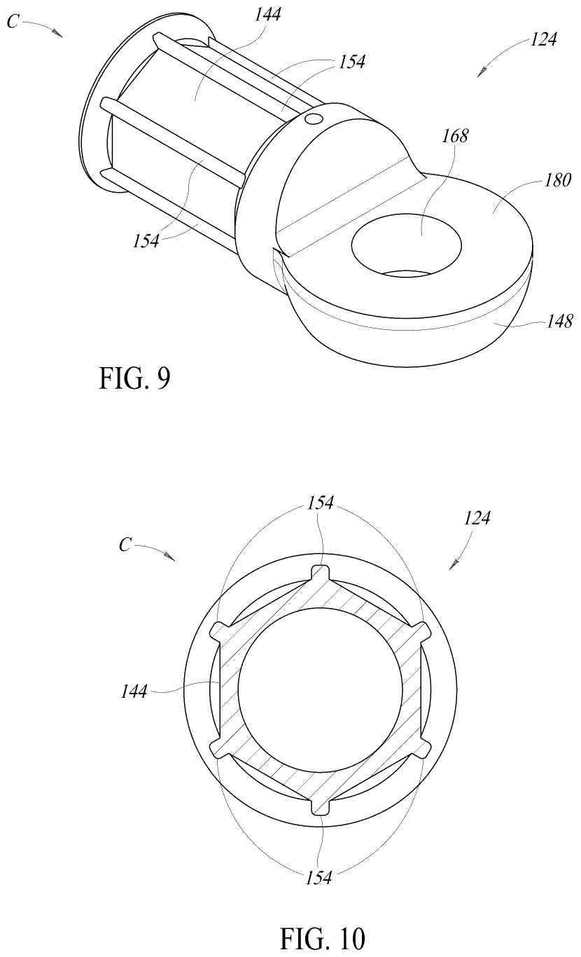

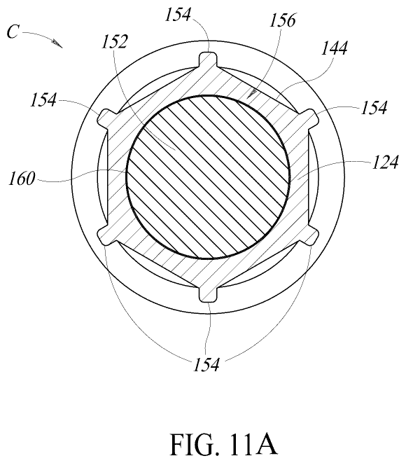

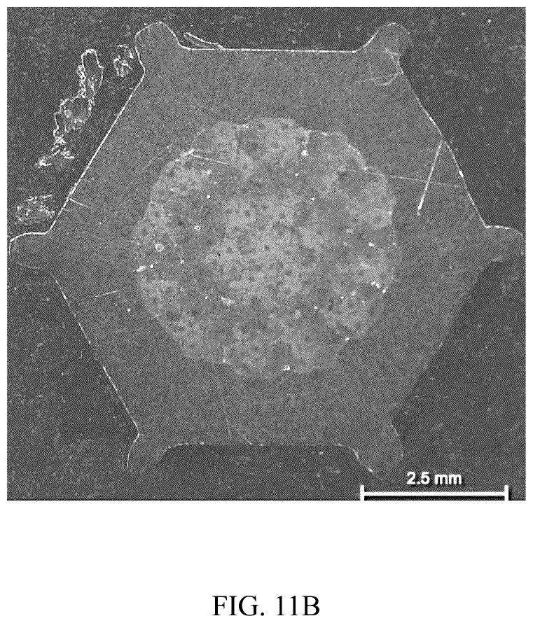

The cable connection portion 144 of the lug connector 124 is configured to be crimped, which transforms the cable connection portion 144 from the initial state I to a crimped (i.e., deformed) state C, an example of which is shown in FIGS. 9 and 10. With the electrically conductive cable 108 received in the cable connection portion 144 prior to the crimping, the crimping compacts wires 152 of the electrically conductive cable 108. An exemplary cross-sectional view of the cable connection portion 144, including the electrically conductive cable 108 therein, when in the crimped state C, is shown in FIG. 11A. FIG. 11B shows an image of a cross-section of cross-section view of a cable connection portion in a crimped state embodying the embodiment of FIG. 11A.

With reference to FIGS. 9 and 10, the crimping may deform the cable connection portion 144 such that the cable connection portion 144 includes a plurality of finger extensions (i.e., protrusions) 154 extending radially outward therefrom when in a crimped state C. When in the deformed state C, the cable connection portion 144 may include six finger extensions 154 equally spaced about a circumference of the cable connection portion 144 with a respective flat section in between each pair of adjacent finger extensions 154.

When in the crimped state C, a cross-section of a crimped portion 156 of a compacted section of wires 152 of the electrically conductive cable 108 may consist of an area 160 of solid metal that is entirely devoid or essentially entirely devoid of any interstitial voids among the compacted section of wires 152 of the electrically conductive cable 108. Such a compaction may enable a resistance across the crimped portion 156 of the compacted section of wires 152 of the electrically conductive cable 108 to be less than 15 microohms, less than 10 microohms, less than 5 microohms, less than 2 microohms, or less than 1.5 microohms.

During crimping, the crimped portion 156 of the compacted section of wires 152 of the electrically conductive cable 108 may decrease in cross-sectional area by between about 8% and about 15%. In some embodiments, crimping may reduce the crimped portion 156 of the compacted section of wires 152 of the electrically conductive cable 108 may decrease in cross-sectional area by between about 7% and about 16%. In some embodiments, crimping may reduce the crimped portion 156 of the compacted section of wires 152 of the electrically conductive cable 108 may decrease in cross-sectional area by between about 10% and about 13%.

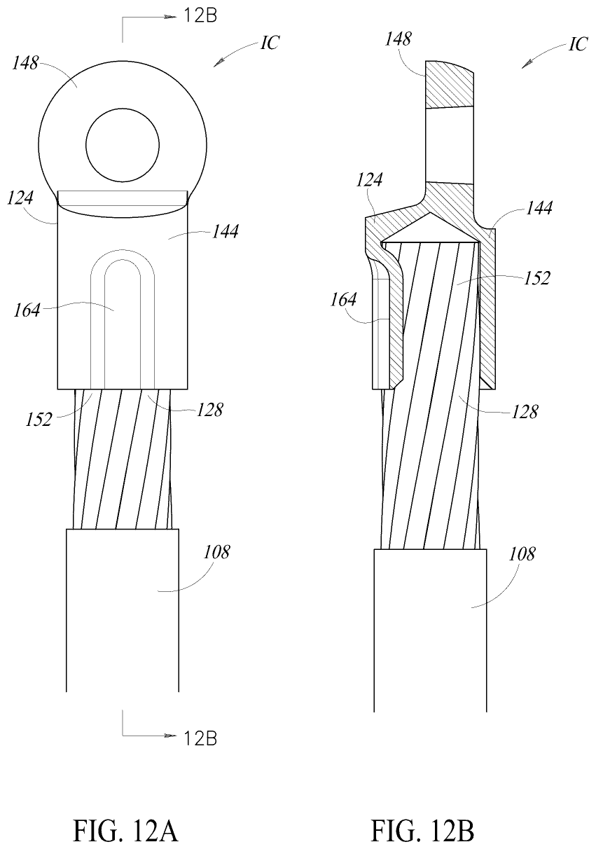

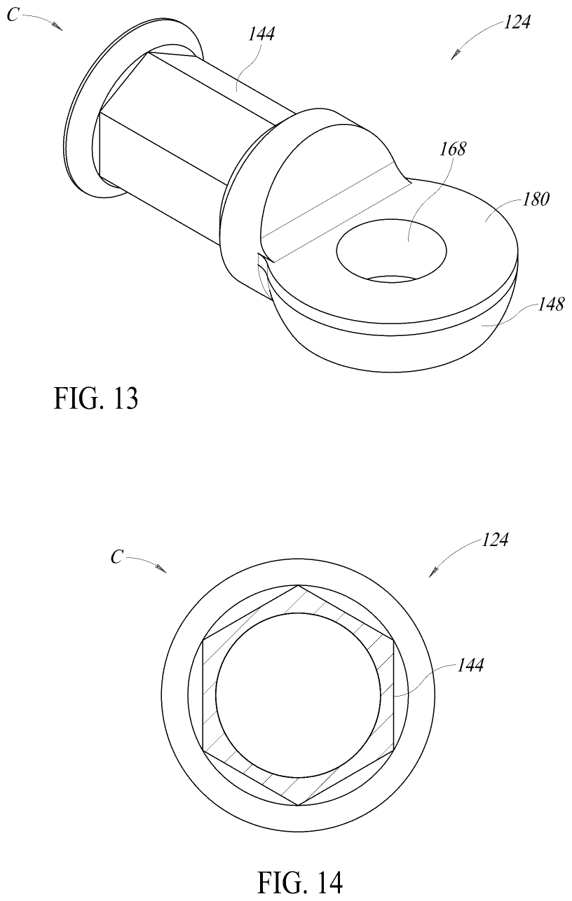

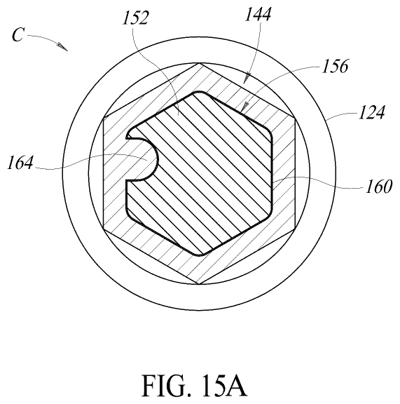

In an alternative embodiment, the cable connection portion 144 of the lug connector 124 may be placed in an initial crimp state IC prior to reaching the crimped state C. The lug connection in the initial crimp state IC is shown in FIGS. 12A and 12B. The cable connection portion 144 in the initial crimp state IC may include a “dimple” 164 imprinted on the cable connection portion 144. FIG. 13 shows the lug connector 124 in a crimped state C subsequent to the initial crimp state IC and FIG. 14 shows a cross-sectional view of the cable connection portion 144, including the electrically conductive cable 108 therein, while in the crimped state C shown in FIG. 13. The cable connection portion 144 may be crimped from the initial circular cross-sectional shape into a hexagonal cross-sectional shape in the crimped state C. Notably, the embodiment shown in FIGS. 13 and 14 shows that the hexagonal cross-sectional shape of cable connection portion 144 need not include the finger extensions extending therefrom.

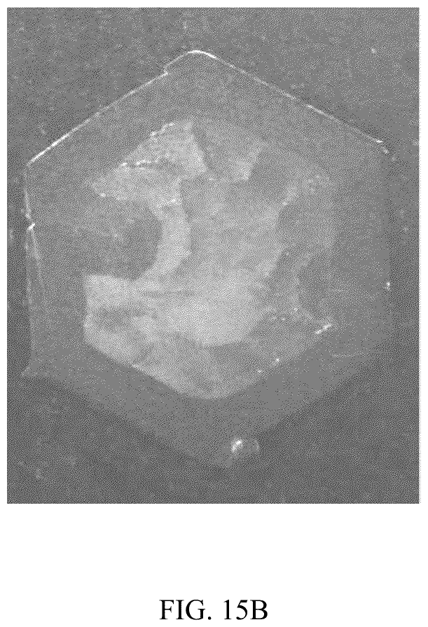

Inclusion of the initial crimp state IC may cause the dimple 164 of the cable connection portion 144 of the lug connector 124 to partially extend inwardly to protrude into a space provided to receive the electrically conductive cable 108 when in the crimped state C, as shown in the embodiment shown in FIG. 15A. FIG. 15B shows an image of a cross-section of cross-section view of a cable connection portion in a crimped state embodying the embodiment of FIG. 15A.

The terminal portion 148 may be configured to be welded to the electrical terminal 112 of the heater 104. The terminal portion 148 may include an aperture 168 extending therethrough. The aperture 168 may be configured to receive the electrical terminal 112 therein. The terminal portion 148 may be configured to be welded to the electrical terminal 112 when the electrical terminal 112 is received in the aperture 168.

Welding of the terminal portion 148 of the lug connector 124 to the electrical terminal 112 may be accomplished via any satisfactory welding method, including laser welding, GTAW, and GMAW, such that the electrical terminal 112 and the terminal portion 148 of the lug connector 124 are joined together to create the welded connection 132. During such welding, shielding gas may include at least one of nitrogen, carbon dioxide, argon, or helium. In some embodiments, a filler material may be deposited during welding to increase the cross-sectional area of an electric current path.

When viewing the terminal portion 148 from a side thereof, the terminal portion 148 may occupy at least a majority of a height H from an outer edge 172 of the crimp ring lug connector 124 to a longitudinal centerline 176 of the crimp ring lug connector 124, and an upper welding surface 180 of the crimp ring lug connector 124 may be provided at or near the longitudinal centerline 176 of the crimp ring lug connector 124.

A method of crimping a lug connector 124 to an electrically conductive cable 108 is described below. The crimping method is described with reference to the embodiments described above. The crimping method begins with introducing the electrically conductive cable 108 into an interior 184 of the cable connection portion 144 of the lug connector 124.

Next, optionally, a dimple 164 may be stamped into the cable connection portion 144 of the lug connector 124. The dimple may be stamped into the cable connection portion 144 by way of a die or a hand tool used by an operator. Such a dimple 164 may improve compaction in the cable connection portion 144 provided in the following steps.

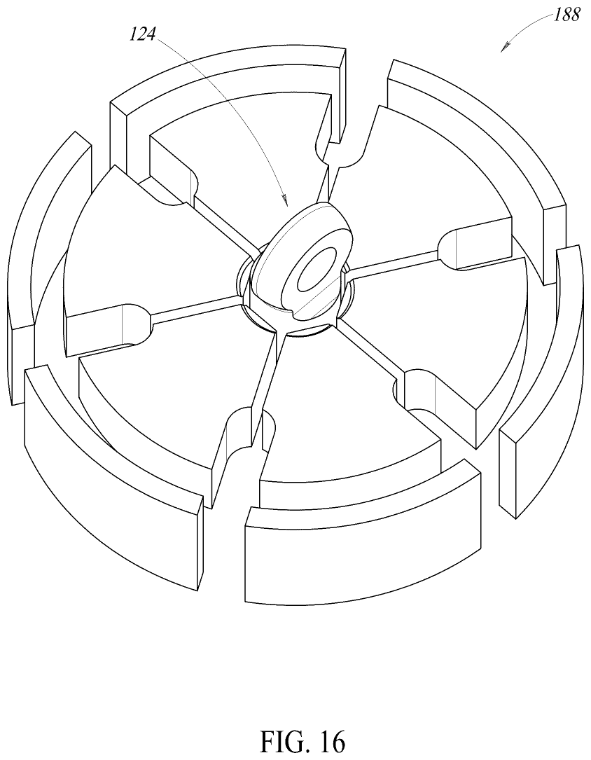

Next, the cable connection portion 144 of the lug connector 124 may be crimped such that the wires 152 of a portion 156 of the electrically conductive cable 108 may be compacted within the cable connection portion 144 of the lug connector 124. Crimping the lug connector 124 includes plastically deforming the lug connector 124. The crimping may be accomplished by inserting the cable connection portion 144 of the lug connector 124 into a die 188 configured to place the cable connection portion 144 into the desired shape, such as a hexagon, such as the die shown in FIG. 16. The die 188 may compress the cable connection portion 144 of the lug connector 124 by way of a hydraulic press, for example.

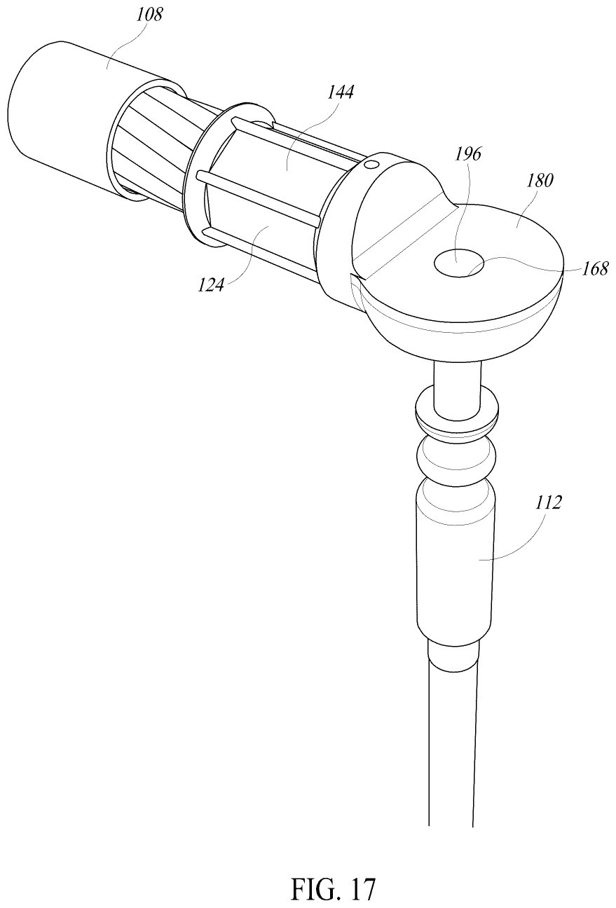

A method of coupling an electrically conductive cable 108 to an electrical terminal 112 of an electric heater is described below. The coupling method is described with reference to the embodiments described above. The coupling method may begin with coupling a lug connector 124 to the electrically conductive cable 108, as described above and shown in FIG. 17. Next, the method may include positioning a heat sink (not shown) to be contacting the cold pin. The heat sink may be coupled to the cold pin by clamping the heat sink to the cold pin. Additionally or alternatively, cold fluid may be circulated through heat shielding or cooling air may be circulated over the cold pin or heat shielding, in order to cool the cold pin before, during, and/or after welding. The cold fluid or cooling air may be compressed air and may be supplied by way of a vortex tube.

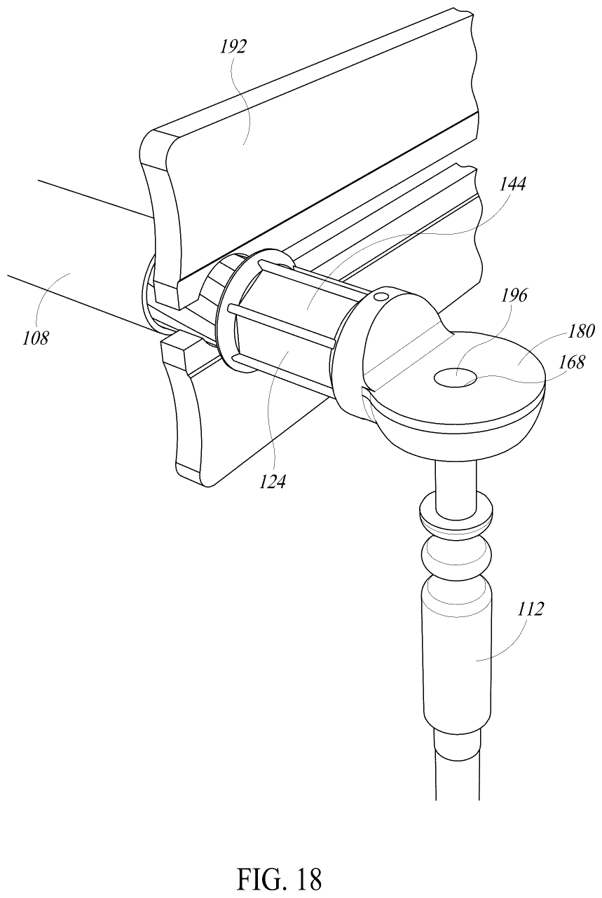

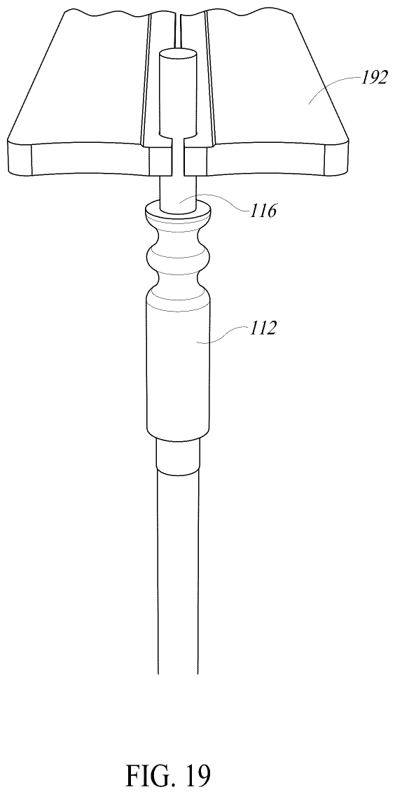

Additionally or alternatively, a pair of heat shields 192 may be positioned on opposing sides of a welding location 196. A first heat shield 192 may be positioned on the electrically conductive cable 108, as is shown in FIG. 18. A second heat shield 192 may be positioned on the electrical terminal 112 to which the electrically conductive cable 108 will be welded, as shown in FIG. 19. The pair of heat shields 192 are configured to reduce heat transfer from welding at the welding location 196 to the electrically conductive cable 108 and the electrical terminal 112, respectively. The heat shields 192 may be configured to absorb thermal energy from the welding operation. The heat shields 192 may be configured as clamps. The heat shields 192 may be cooled prior to positioning on the electrically conductive cable 108 and the electrical terminal 112. The heat shields 192 may be cooled in a cooling fluid comprising liquid nitrogen, for example. The heat shields 192 may be soaked in the cooling fluid until the heat shields 192 are cooled to a predetermined temperature.

Next, the lug connector 124 may be welded to the electrical terminal 112 of the electrically powered heater 104. Such a welded connection 132 may enable a low resistance electrical connection and a rigid mechanical connection to be formed between the electrically conductive cable 108 and the electrical terminal 112 of the electrically powered heater 104. The lug connector 124 coupled to the electrically conductive cable 108 may be the lug connector 124 described above, though this is not required. When the electrical terminal 112 of the electrically power heater 104 is extended through the aperture 168 prior to the welding, a top surface 204 of the electrical terminal 112 of the electrically powered heater 104 may be coplanar with upper welding surface 180 of the lug connector 124. In some embodiments, the top surface 204 of the electrical terminal 112 of the electrically powered heater 104 may slightly extend past the upper welding surface 180 of the lug connector 124.

In embodiments in which the electrical terminal 112 is a cold pin, the lug connector 124 may be welded to the core 116 of the cold pin. In embodiments in which the cold pin includes a taper cover 120, the lug connector 124 may be welded to the taper cover 120.

The lug connectors and associated methods described herein may be adapted to a variety of pieces of equipment or machinery, including those not related to exhaust after-treatment systems. Such lug connectors may provide improved electrical connections in high temperature environments and/or electrical connections which are prone to failure.

The devices and systems of the disclosure each have several innovative aspects, no single one of which is solely responsible or required for the desirable attributes disclosed herein. The various features described above may be used independently of one another, or may be combined in various ways. All possible combinations and subcombinations are intended to fall within the scope of this disclosure. Various modifications to the implementations described in this disclosure may be readily apparent to those of ordinary skill in the art, and the generic principles defined herein may be applied to other implementations. Thus, the claims are not intended to be limited to the implementations shown herein, but are to be accorded the widest scope consistent with this disclosure, the principles and the novel features disclosed herein.

Certain features that may be described in this specification in the context of separate implementations also may be implemented in combination in a single implementation. Conversely, various features that may be described in the context of a single implementation also may be implemented in multiple implementations separately or in any suitable subcombination. Moreover, although features may be described above as acting in certain combinations and even initially claimed as such, one or more features from a claimed combination can be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

In general, in the following claims, the terms used should not be construed to limit the claims to the specific embodiments disclosed in the specification and the claims, but should be construed to include all possible embodiments along with the full scope of equivalents to which such claims are entitled.

1. A crimp ring lug connector comprising:
a cable connection portion configured to insertably receive an electrically conductive cable therein; and
a terminal portion configured to be welded to an electrical terminal of an electric heater,
wherein the crimp ring lug connector is configured to conduct electricity from the electrically conductive cable to the electrical terminal of the electric heater.

2. The crimp ring lug connector of claim 1, wherein the terminal portion includes an aperture extending therethrough, the aperture configured to receive the electrical terminal therein, and wherein terminal portion is configured to welded to the electrical terminal when the electrical terminal is received in the aperture.

3. The crimp ring lug connector of claim 1, wherein the cable connection portion is configured to be crimped from an initial circular cross-sectional shape into a hexagonal cross-sectional shape.

4. The crimp ring lug connector of claim 3, wherein, in a crimped state, the cable connection portion of the crimp ring lug connector is configured to partially extend inwardly to protrude into a space provided to receive the electrically conductive cable.

5. The crimp ring lug connector of claim 1, wherein the cable connection portion is configured to be crimped to the electrically conductive cable such that a resistance across a crimped portion of a compacted section of wires of the electrically conductive cable is less than 15 microohms.

6-11. (canceled)

12. An exhaust after-treatment system configured to reduce emissions present in exhaust received from an engine, the exhaust after-treatment system comprising:
an electrically powered heater configured to selectively heat one or more components of the exhaust after-treatment system and/or exhaust moving through the exhaust after-treatment system during operation, the electrically powered heater including a heating element and at least one electrical terminal operatively coupled to the heating element for selectively supplying electrical power thereto; and
at least one electrically conductive cable configured to supply electrical power to the electrically powered heater, the at least one electrically conductive cable including a lug connector on a terminal end thereof, and wherein the at least one electrically conductive cable is coupled to the at least one electrical terminal of the electrically powered heater by a welded connection directly between the lug connector of the at least one electrically conductive cable and the at least one electrical terminal.

13. The exhaust after-treatment system of claim 12, wherein the at least one electrically conductive cable is welded to the at least one electrical terminal at an inlet of the exhaust after-treatment system, and wherein the electrically powered heater is configured to heat the inlet of the exhaust after-treatment system.

14. The exhaust after-treatment system of claim 12, wherein the exhaust after-treatment system further comprises an SCR module, and wherein the at least one electrically conductive cable is welded to the at least one electrical terminal at the SCR module, and wherein the electrically powered heater is configured to heat the SCR module of the exhaust after-treatment system and/or a region of the exhaust after-treatment system proximate the SCR module.

15. The exhaust after-treatment system of claim 12, wherein the lug connector is crimped onto the terminal end of the electrically conductive cable such that a crimped portion of the electrically conductive cable is compacted.

16. The exhaust after-treatment system of claim 15, wherein a crimped portion of the lug connector includes an exterior hexagonal shape.

17. The exhaust after-treatment system of claim 15, wherein the electrically conductive cable is compacted such that a resistance across the crimped portion of the compacted electrically conductive cable is less than 15 microohms.

18-20. (canceled)

21. The emissions treatment system of claim 12, wherein the lug connector comprises:
a cable connection portion configured to insertably receive an electrically conductive cable therein; and
a terminal portion configured to be welded to an electrical terminal of an electric heater,
wherein the crimp ring lug connector is configured to conduct electricity from the electrically conductive cable to the electrical terminal of the electric heater.

22. A method of coupling an electrically conductive cable to an electrical terminal of an electric heater, the method comprising:
coupling a lug connector to the electrically conductive cable; and
welding the lug connector to the electrical terminal of the electric heater,
wherein a low resistance electrical connection and a rigid mechanical connection is formed between the electrically conductive cable and the electrical terminal of the electrical heater.

23. The method of claim 22, wherein coupling of the lug connector to the electrically conductive cable includes crimping the lug connector with the electrically conductive cable therein.

24. (canceled)

25. The method of claim 23, wherein the crimping compacts a crimped portion of wires of the electrically conductive cable.

26. The method of claim 25, wherein the wires of the electrically conductive cable are compacted such that a resistance across the crimped portion of the compacted wires of the electrically conductive cable is less than 15 microohms.

27. (canceled)

28. The method of claim 22, further comprising positioning a pair of heat shields on opposing sides of a welding location prior to the welding,
wherein a first heat shield of the pair of heat shields is positioned on the electrically conductive cable and a second heat shield of the pair of heat shields is positioned on the electrical terminal, and
wherein the pair of heat shields are configured to reduce heat transfer from a welding connection on a first side of each respective heat shield to a second side of each respective heat shield.

29. The method of claim 28, further comprising cooling the pair of heat shields prior to positioning the heat shield on the opposing sides of the welding location.

30-33. (canceled)

34. The method of claim 22, further comprising stamping a dimple into the lug connector prior to coupling the lug connector to the electrically conductive cable.

35. The method of claim 22, wherein the lug connector comprises:
a cable connection portion configured to insertably receive an electrically conductive cable therein; and
a terminal portion configured to be welded to an electrical terminal of an electric heater,
wherein the crimp ring lug connector is configured to conduct electricity from the electrically conductive cable to the electrical terminal of the electric heater.

36-42. (canceled)
